(19) United States
(12) Patent Application Publication
(10) Pub. No.: US 2005/0252076 A1
(43) Pub. Date: Nov. 17, 2005

(54) Trellis system

(75) Inventors: Christopher M. Schloesser, Hudson, WI (US); Greg T. Berg, Kingsburg, CA (US)

Correspondence Address: MERCHANT & GOULD PC, P.O. BOX 2903, MINNEAPOLIS, MN, 55402-0903, US

(73) Assignee: Oxbo International Corporation, Byron, NY (US)

(21) Appl. No.: 10/846,846

(22) Filed: May 14, 2004

(51) Int. Cl. A01G 17/06

(52) U.S. Cl. 47/46

(57) ABSTRACT

A trellis system includes trellis assemblies supporting wires. The wires are retained on wire clips mounted on folding arms. The arms include first and second portions that are pivotally mounted to one another and to a support. The arm assemblies have locks for retainably positioning the first and second portion of the arms relative to the one another and to the support portion of the trellis. In a first embodiment, the trellis is configured as a vertical position trellis, in a second embodiment as a “T” type trellis and, in a third embodiment, as a lyre type trellis. In each configuration, the arm assemblies are moved from a lowered position during the dormant season, to a partially raised position when the vines achieve partial growth, and to a raised, extended position as full growth is achieved.

### BACKGROUND OF THE INVENTION

1. Field of the Invention

The present invention relates to a trellis system and in particular, to a trellis system used for supporting grapes and other similar types of vines and for adjusting the position of trellis arms and foliage support wires.

2. Description of the Prior Art

Trellises have long been used to support and train vines, such as grapes, to optimize the yield and quality of the harvested fruit. Grapes are traditionally cultivated using labor intensive processes with much of the work being done by hand. Green shoots from the current growing season, generally referred to as foliage, are supported at different stages of the growing cycle by wires mounted on trellises. In addition to various thinning and pruning steps that may occur, movement of the wires supporting the grapevines has been traditionally performed by hand.

Wires are generally moved into a preseason storage position at a time that is convenient during the dormant season, prior to the start of the growing season. During the dormant season, pruning operations may be conducted while the wires are in late season foliage positions. Following pruning, the wires are moved into preseason storage positions. As the growing season progresses, the movable foliage support wires are used to position and hold the current year's shoot growth as determined by the type of trellis system used, to provide support as the canopy continues to grow. Additional steps in vineyard management include shoot thinning, removal of water sprouts and other non-fruitful shoots, shoot positioning, leaf removal and fruit thinning. The various operations are conducted to optimize the yield and quality of the grapes.

Previously, the vineyard management operations were performed by hand and were labor intensive. The cost of such labor was high. Improvements in mechanizing the cultivation process and the various thinning and positioning steps have recently been made. Although such advances have decreased the labor required, other operations must still be performed by hand and several of the operations are extremely time consuming. It can be seen that even if some of the operations are performed by hand, but could be performed in a more efficient manner, further cost savings could be achieved and the overall efficiency of vineyard management could be improved. Moreover, some trellis systems do not adapt well to use with mechanized equipment.

One highly labor intensive operation of a vineyard is the movement of wires from one position to another. Prior art methods utilize various trellis configurations that support one or more wires, often supporting wires on each side of the trellis. The foliage support wires are retained by a retainer, such as a clip or a notch in the cross-arm or trellis, which allows the wire to be removed from the retainer at its current position and moved to a different position on the trellis, thereby changing the position of the wire. Such processes provide proper positioning, but are labor intensive and have shortcomings. In addition to the time and labor involved in removing a wire from a clip and retaining the wire by another clip, other problems exist. Due to the movement of the wire, the tension and slack that needs to be built into the trellis system may not provide optimal support of the foliage for all positions. Moreover, due to human error, foliage wires are commonly crossed or entangled during the repositioning process. This problem is compounded where multiple wires are supported on each side of the trellis. Time spent in untangling and adjusting tension in the wires requires further labor and time, thereby increasing vineyard management costs. Improperly tensioned or positioned wires cause particular difficulties during dormant season machine pruning operations, due to inadvertent collision or entanglement with the foliage support wires. Some wires may be cut or break while being moved, requiring further repair, with increased equipment and labor costs.

Although new trellis systems have been developed that aim to reduce the cost and to provide some flexibility for initial positioning of trellis arms and supports for wires, such systems also suffer from the shortcomings related to moving the wire from one position on the trellis to another position on the trellis and the tangling problems that may occur with detaching and reattaching the wire.

Examples of devices that have sought to improve trellis systems include those shown in U.S. Pat. No. 6,138,407 to Pierce, Jr., U.S. Pat. No. 6,145,246 to Galbraith, U.S. Pat. No. 6,237,282 to Pitts, U.S. Pat. No. 6,405,479 to Sherman and U.S. Pat. No. 6,434,883 to Martin. The trellis systems in these patents provide improvements for the trellis, but do not address the issues surrounding moving wires supported on the trellis.

It can be seen that a new and improved system and method for moving wires on trellises is needed. Such a system should avoid problems due to changes in tension and the need to retension wires on the trellises. Such a system should also provide for an inexpensive and durable trellis system, including the wires and supports, which is easily adaptable to mechanized grape management processes. Such a system should also allow for movement of the wires without detaching the wires from the trellis, thereby avoiding the problems associated with tangling. Such a trellis system should also be easy to operate and quickly and easily actuated. The present invention addresses these as well as other problems associated with trellis systems.

### SUMMARY OF THE INVENTION

The present invention is directed to a trellis system for training grapevines. The trellis system includes trellis assemblies that retain and support wires for supporting the current year's growth and allows for easily moving the wires at various times during the growing cycle with the wires remaining retained by wire clips at all times

Each trellis assembly generally includes a post and a mounting portion that supports arm assemblies. The arm assemblies generally include a first arm portion and a second arm portion. The first arm portion is generally pivotally mounted to a cross member support portion mounted to the post and the second arm portion is pivotally mounted to the first arm portion. The arm portions are pivotally mounted so that they may be rotated to different positions. The arms may include pivots with flexible bushings that allow for rotation, but provide resistance to free rotation so that the arm assemblies may hold their position against the weight of supported wires and foliage. The arm assemblies also include locks that allow operators to place the arms at preselected orientations with a positive mechanical engagement to hold the arm assemblies at a predetermined position. In one embodiment, the locks have a raised portion on one element inserting into a complementary orifice of another element. The arm assemblies have wire retainers that allow the wire to slide through the clip, but the clip retains the wire while the arm is moved to different positions.

In a first embodiment, a vertical shoot positioning trellis system, commonly referred to as VSP, includes two arm assemblies mounted on an attachment portion on the top of a post. The post or attachment portion supports a cordon wire for supporting the cordon. The arm assemblies may be moved from a storage or dormant position, wherein the arm assembly extends substantially downward, to a partial growth position, wherein the first arm portion extends upward while the second arm portion extends back downward doubling up upon the first arm portion. In a full growth position, the first arm portion and second arm portion extend substantially upward and are locked in position. The arm assemblies are moved back down to a lowered position after harvest and dormant pruning.

In a second embodiment, a T-type trellis includes an arm assembly mounted at each end of a cross member. The arm assemblies function and are positioned in substantially the same way as the vertical shoot position trellis. During the dormant season and initial growth stages, the arm assemblies extend substantially downward. When partial growth has occurred, the arm assembly is pivoted upward so that the first arm portion extends upward and the second arm portion extends back down upon the first arm portion. When nearing full growth, the second arm portion is rotated relative to the first arm portion so that both arm portions extend substantially upward in a full extended position. Following harvest and dormant pruning, the arm assemblies are moved back down to the storage position during the dormant season.

According to a third embodiment of the present invention, U-type or Lyre-type trellis systems may utilize folding arm assemblies. The Lyre-type trellis system includes a cross member with inner arms and outer arms mounted to the cross member. In the dormant position, the outer arms extend downward with the second arm portion folded back around the first arm portion in a manner similar to the vertical shoot position and “T” type trellis embodiments. The inner arm assemblies have a first portion extending upward and slightly inward and a second portion extending downward. When partial growth has occurred, the arm assemblies are moved to a position wherein the first arm portion extends substantially upward and the second arm portion is folded back upon the first arm portion. The outer arm assemblies generally pivot outward and upward while the inner arm assemblies generally pivot from the inner position outward. When the shoots are nearing full growth, the arm assemblies are moved to a further position wherein all arm assemblies are directed substantially upward and extended. The outer arm assemblies are moved to the fully upward extending position by folding the second portion outward and upward while the inner assemblies have the second arm portion rotating inward and upward. Following harvest and dormant pruning, the arms may be moved back to the lowered, dormant season position.

It can be appreciated that the present invention provides for movement of the wires between various elevations without removing the wires from the trellises. Moreover, the arms are able to fold between various heights without overlapping or impinging upon the other arms. The wires remain consistent from one trellis support post to another so that no tangling may occur. The trellis system provides for moving wires in a safe, fast and reliable manner that is more efficient than moving the wire from location to location on the trellis by the act of releasing and reattaching the wire. The trellis system provides for easily adapting to mechanized grape management operations such as shoot thinning, fruit thinning, dormant pruning, mechanical harvesting and other mechanized vineyard management techniques.

These features of novelty and various other advantages that characterize the invention are pointed out with particularity in the claims annexed hereto and forming a part hereof. However, for a better understanding of the invention, its advantages, and the objects obtained by its use, reference should be made to the drawings that form a further part hereof, and to the accompanying descriptive matter, in which there is illustrated and described a preferred embodiment of the invention.

### BRIEF DESCRIPTION OF THE DRAWINGS

Referring now to the drawings, wherein like reference numerals and letters indicate corresponding structure throughout the several views:

FIG. 1 is a perspective view of a prior art grape vine trellis system;

FIG. 2 is a perspective view of a first embodiment of a grape vine trellis system according to the principles of the present invention in a first configuration;

FIG. 3 is an end view of the trellis system shown in FIG. 2 in a second configuration;

FIG. 4 is an end view of the trellis system shown in FIG. 2 in a third configuration;

FIG. 5 is an end view of a second embodiment of a grape trellis system according to the principles of the present invention;

FIG. 6 is an end view of the trellis system shown in FIG. 5 in a second configuration;

FIG. 7 is an end view of the trellis system shown in FIG. 5 in a third configuration;

FIG. 8 is an end view of a third embodiment of a grape trellis system according to the principles of the present invention;

FIG. 9 is an end view of the trellis system shown in FIG. 8 in a second configuration;

FIG. 10 is an end view of the trellis system shown in FIG. 8 in a third configuration;

FIG. 11 is a detail view of a portion of an arm for the trellis systems of the present invention in a retracted position; and

FIG. 12 is a detail view of the portion of an arm shown in FIG. 11 in an extended position.

### DETAILED DESCRIPTION OF THE PREFERRED EMBODIMENT

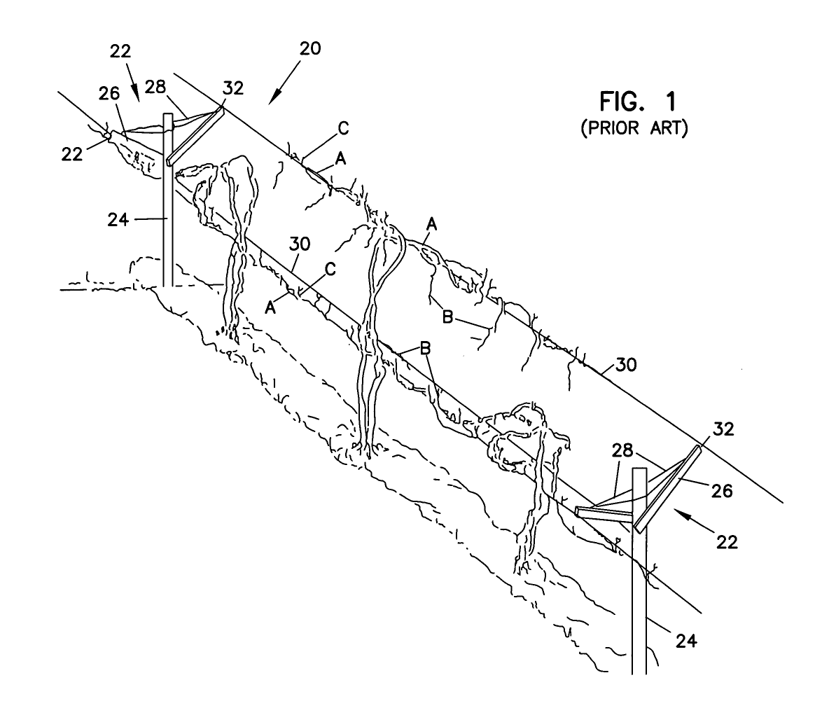

Referring now to the drawings, and in particular to FIG. 1, there is shown a prior art trellis system, generally designated 20. Although a Geneva Double Curtain (GDC) trellis is shown, other trellis variations are well known that support one to four wires. Many trellis configurations exist for various grape varieties, regions and practices. The present invention is applicable to many trellis types, however only several are described, but one of ordinary skill in the art could easily adapt the present invention to many other trellis types. Most trellis types may be modified and/or retrofitted according to the principles of the present invention. Examples of trellis arrangements that may be adapted to the present invention include, but are not limited to: VSP (vertical shoot positioned), T-top, California sprawl and other single curtain type trellis systems, Scott-Henry, Smart-Dyson and other single curtain vertically divided type trellis systems, quadrilateral sprawl, Livingston Double Curtain (LDC), Lyre, modified Lyre, Geneva Double Curtain (GDC) and other double curtain horizontally divided type trellis systems, Smart-Dyson Ballerina and other multiple curtain divided canopy trellis systems, as well as other similar trellis systems.

As shown in FIG. 1, the typical trellis system 20 includes trellis assemblies 22 arranged in rows and spaced apart to support wires 30. Each trellis assembly 22 typically includes a post 24 and arms 26. In the embodiment shown in FIG. 1, arm support wires 28, not needed for several trellis types, support the arms 26 and attach to the post 24. Wire clips 32 are positioned at the end of the arms 26 and retain the wires 30. In addition, a wire 30 may be supported by clips mounted directly on the post 24 at a position lower than at the end of the arms 26 to support the cordon. In a typical embodiment, the cordon wire 30 supported on the post 24 may be at a height of 52 inches while the foliage support wires 30 supported at the arms 26 may be at the height of approximately 69 inches. Spacing between the foliage support wires 30 may be, for example, 48 inches while a typical spacing between the posts may be 24 feet. It can also be appreciated that the trellis style and spacing may vary, depending upon the trellis type, the grape variety, the geography, growth practices, and other conditions.

Multiple grapevines grow up between the posts 24 and are supported on the wires 30. For typical grape varieties, the current year's shoots will be moved at some point during the growing season. Such support and placement of the shoots is commonly referred to as shoot positioning. The main horizontal portion of the vine is typically referred to as a cordon, designated A. The wire 30 upon which the cordon A is supported is commonly referred to as a cordon wire, which is typically never moved. Growing off of the cordon A is foliage including shoots B, with renewal and fruiting spurs C originating from various positions along the cordon A. In addition to shoot positioning, the grapes may require fruit and leaf thinning and/or dormant pruning, and/or shoot thinning, depending upon the vineyard management practices employed. It can be further appreciated that the efficiency of such operations is increased if the trellis systems easily allow for mechanical pruning and thinning.

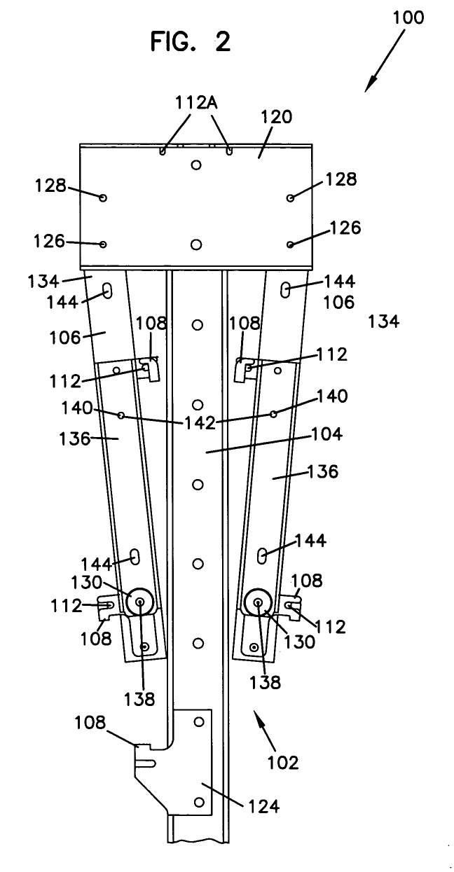

Referring now to FIGS. 2-4, there is shown a first embodiment of a grape trellis system according to the principles of the present invention, generally designated 100. The trellis system 100 includes a trellis assembly 102. The trellis assembly 102 supports wires 112 to support the foliage in a typical manner similar to that shown in FIG. 1. The trellis system 100 shown in FIGS. 2-4 is generally known as a vertical shoot positioned system (VSP). It can be appreciated that modifications to arm and post configurations may be made to the trellis system 100 that fall within the scope of the present invention.

The trellis system 100 includes spaced apart trellis assemblies 102. Each trellis assembly 102 includes a post 104. The post 104 may be of standard design and may be wood or may be a standard metal post that is driven into the ground at spaced apart locations in rows to support the grape vines. The trellis assemblies 102 are preferably spaced apart so that mechanized equipment may be driven between the rows to conduct various positioning, thinning, pruning and harvesting operations. The post 104 supports an attachment portion 120 supporting arm assemblies 106. The post attachment portion 120 and arm assemblies 106 are preferably made of a weather resistant material, such as an inexpensive, treated steel or alloy. However, other suitable materials may also be utilized. It can be appreciated that the post attachment portion 120 is configured to mount to either a metal post or a wood post and the attachment portion 120 and arm assemblies 106 may be retrofitted to an existing post for adapting a vineyard to practice the trellis systems of the present invention. The post and attachment portion 120 are configured for accepting attachment of an overhead sprinkler system (not shown) where such type of irrigation is practiced. The trellis assemblies 102 support wires 112 on wire clips 108. In the embodiment shown in FIGS. 2-4, up to four foliage support wires 112 may be supported on the trellis system 100. A cordon wire 112A, which is typically stationary, is supported on the post 104 or attachment portion 120 and supports the cordons of the grape plants.

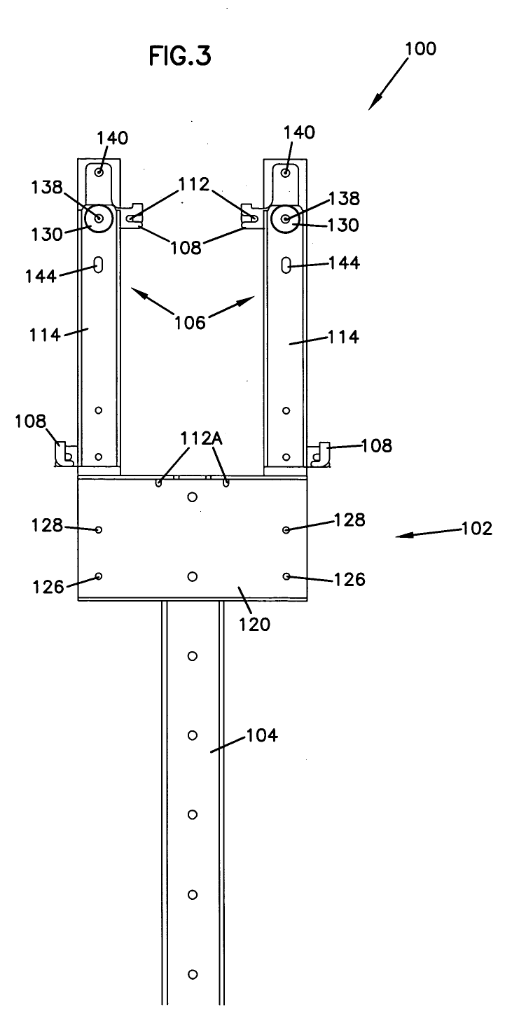

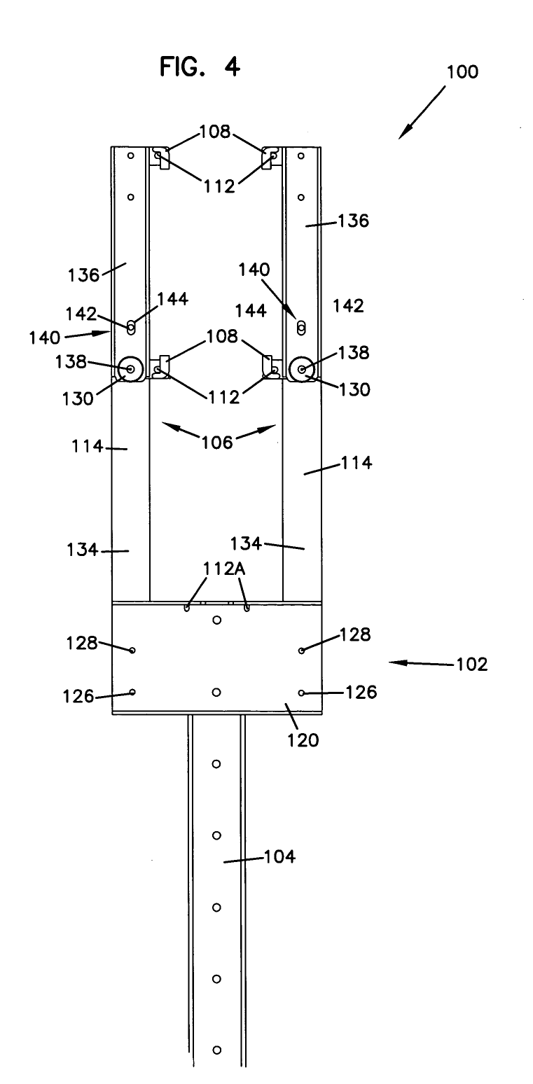

As shown in FIGS. 2-4, the arm assemblies 106 are adjustable and may be moved between various positions. The arm assemblies 106 are moved from position to position at different stages of the growth cycle. During the dormant season, the arm assemblies 106 are preferably at a storage position as shown in FIG. 2. During the course of the season, grapes may be repositioned and supported with the arm assemblies 106 being moved to the partial growth position shown in FIG. 3. When the grapevines are at substantially full growth, the arm assemblies 106 are moved to the position shown at FIG. 4. Following harvest and dormant pruning operations, the arm assemblies 106 are moved from the full growth position shown in FIG. 4, back to the storage position shown in FIG. 2 for the dormant season and the initial stages of the growing season.

Referring again to FIGS. 2-4, each of the arm assemblies 106 includes a first arm portion 134 and a second arm portion 136. The first arm portion 134 is pivotally attached to the post attachment 120 at a pivot 126. A second arm portion 136 is pivotally attached to the first arm portion 134 at a pivot 138. The pivots 128 and 138 include flexible bushings 130, such as a rubber washer. The pivots 126 and 138 have sufficient friction to hold the arm assemblies 106 in place without swinging freely. In addition, locks 128 and 140 retain the arm assemblies 106 with the arm portions 134 and 136 extended at preselected positions, such as the raised arm positions shown in FIG. 4. The locks 128 and 140 include raised portions 142 extending from the post attachment 120 and the end of the first arm portion 134. Complementary receiver portions 144 in the form of orifices sized to receive the raised portions 142 are formed in the first and second arm portions. When the raised portion 142 is aligned with the associated orifice of the receiver portion 144, the arm portions 134 and 136 remain in position, even while raised and supporting loaded wires 112. It can be seen in the dormant position shown in FIG. 2 that the second arm portion 136 is locked to the first arm portion 134. The first arm portion 134 extends downward and does not need to be locked into position. In the partial growth position shown in FIG. 3, the first arm portion 134 is locked relative to the post attachment 120. In addition, the second arm portion 136 generally extends in a folded position vertically downward from its pivot 126 and thus, does not need to be locked in position. In the full growth position shown in FIG. 4, both the first arm portion 134 and the second arm portion 136 are locked and extend vertically upward. The locks 128 and 140 are both engaged so that the arms 114 cannot be moved and are able to support the wires 112, which are able to support the foliage at the elevated position.

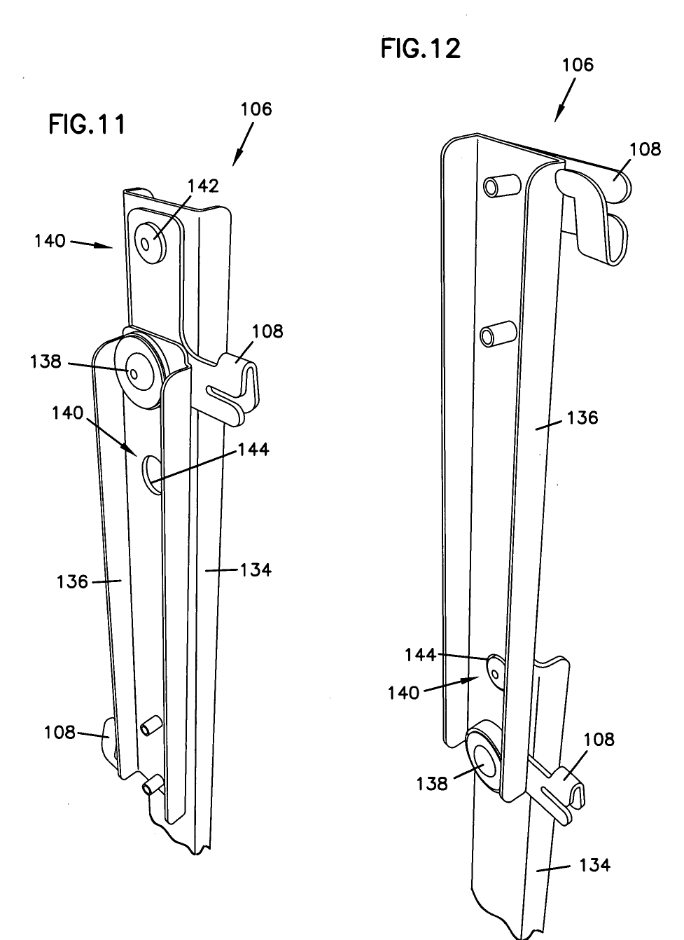

Referring to FIGS. 11 and 12, each of the wire clips 108 includes a first portion with a slot formed therein and a second spaced apart hook portion. It can be appreciated that a wire may simply be placed under the hook and slid into the slot and is retained in the wire clip 108. The wire clip 108 allows the wire 112 to slide back and forth even when retained. However, the hook and slot of the wire clip 108 function to keep the wire 112 retained so that wire 112 does not accidentally slip from the wire clip 108. The wire clip 108 also functions to retain the wire 112 even when the arms 114 are being moved between various positions. Retaining the wires while allowing relative sliding between the wire 112 and the clip 108 also allows for tensioning of the wires on the end of the row rather than from trellis to trellis. Moreover, it can be appreciated that as the wires 112 are retained in the clips 108 while being moved from one elevation to the next, problems from pulling the wire out and entangling wires while moving them are eliminated. As shown in FIG. 2, a lower mounting bracket 124 may be utilized in some embodiments to support a vineyard irrigation system.

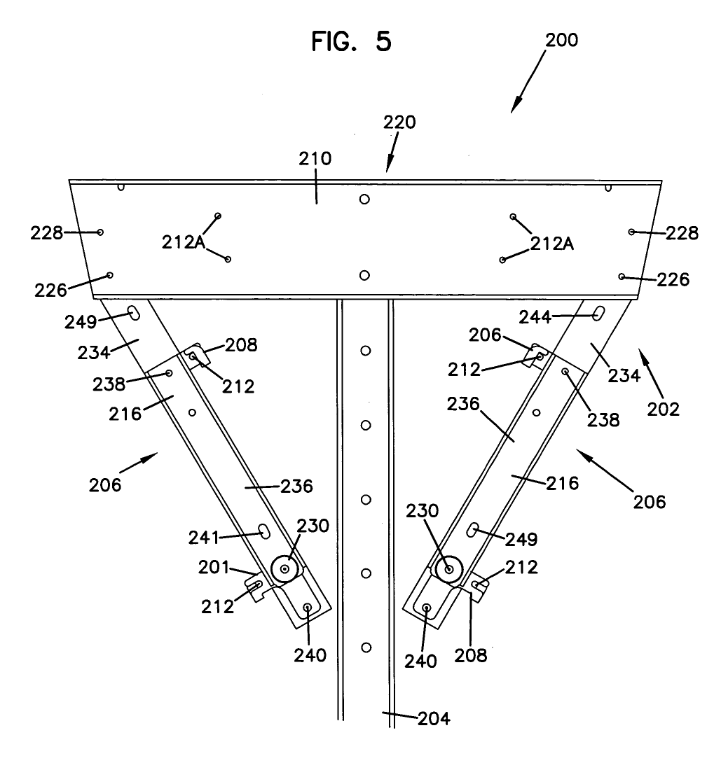

Referring now to FIGS. 5-7, there is shown a second embodiment of a trellis system according to the principles of the present invention, and generally designated 200. The trellis system 200 is similar to the trellis system 100, but includes a cross member 210, which spaces arm assemblies 206 further from one another rather than the arm assemblies 106 of the vertical shoot positioning trellis alignment shown in FIG. 2-4. As shown in FIGS. 5-7, the trellis system 200 includes a number of individual trellis assemblies 202 supporting wires 212. Each trellis assembly 202 generally includes a post 204 supporting the cross member 210 and the arm assemblies 206. Each of the arm assemblies 206 includes an arm 214 having a first portion 234 and a second portion 236. Each of the first and second portions 234 and 246 supports a wire clip 208 that retains a wire 212. The arm assemblies 206 including the first arm portions 234 and second arm portions 236 are similar to the arm assemblies 106 shown in FIGS. 2-4. Moreover, the wire clips 208 are similar to the wire clips 108. The cross member 210 has a center post attachment that is adaptable to metal or wood posts and may be retrofitted to existing vineyards. The cross member 210 has two orifices, each supporting a stationary cordon wire 212A. Each cordon wire 212A supports cordons from the grapes.

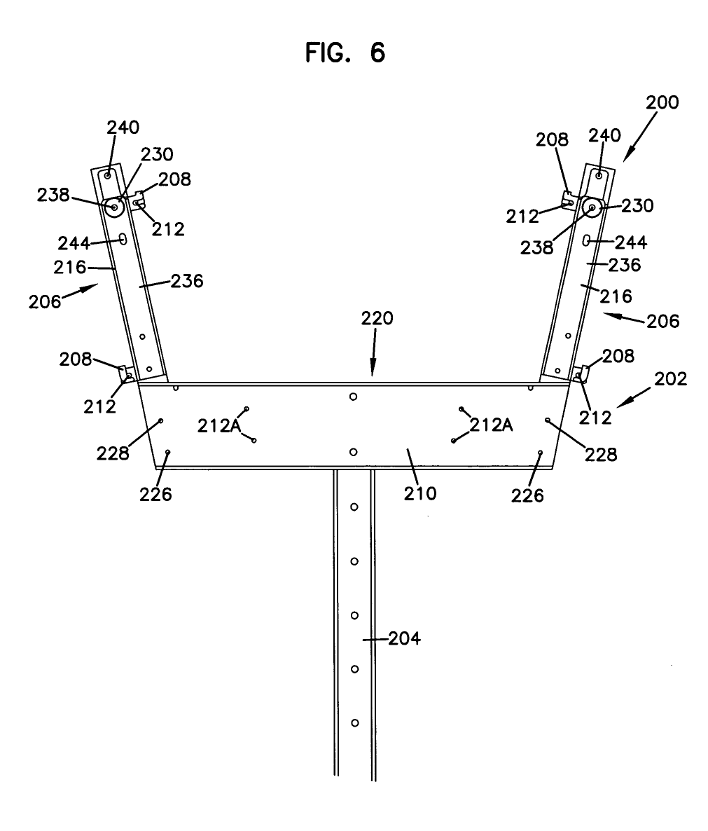

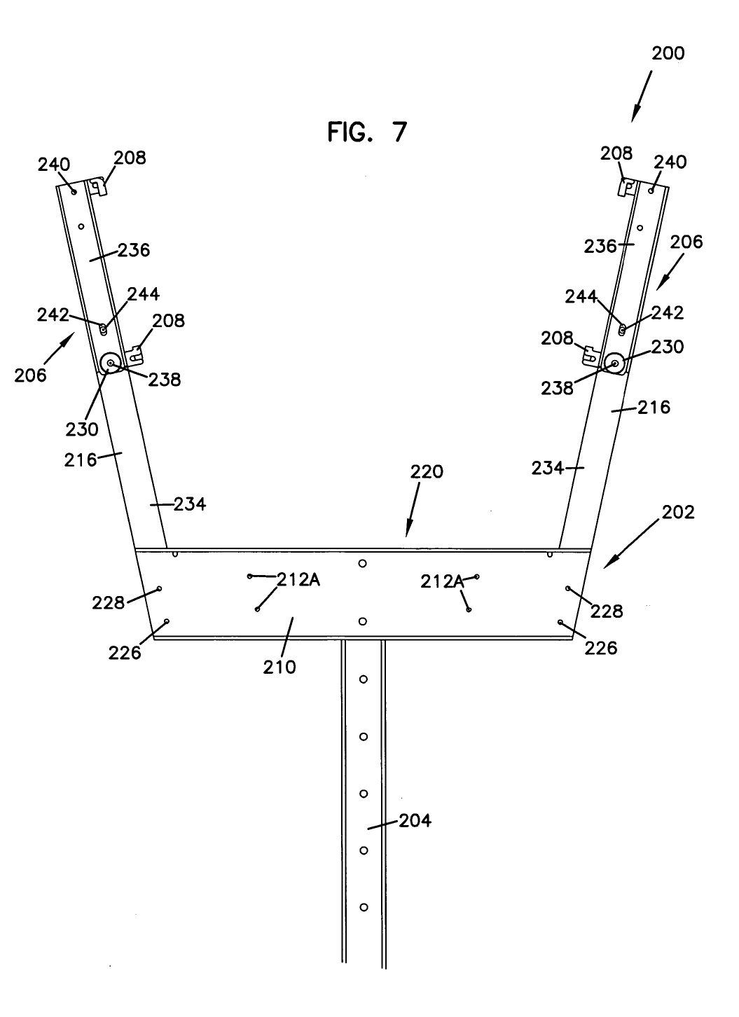

Each of the arms 214 has a first portion 234 and a second portion 236. The arm assemblies 206 mount to the cross member 210 on a pivot 226 and are retained in a raised position, such as shown in FIGS. 6 and 7 by a lock 228. The second arm portion 236 pivotally mounts to the first arm portion 134 at a pivot 238 and is retained by a lock 240. The pivots 226 and 238 include a flexible bushing 230 that allows rotation, yet retains the arms 214 by frictional engagement. The locks 228 and 240 include raised portions 242 and complementary receiver portions 244 in the form of an orifice similar to the locks 128 and 140, with the raised portions 142 and the complementary receiving portions 144 shown in FIGS. 2-4.

Although the trellis system 200 is configured differently than the trellis system 100, the operation is substantially the same. As shown in FIG. 5, the arms 214 are lowered to a storage position for the dormant season. As the growing season advances, the foliage is moved to a higher position and the arms 214 are moved to the position shown in FIG. 6. It can be appreciated that in both the positions shown in FIGS. 5 and 6, the second arm portion 236 is folded back upon the first arm portion 234. In the position shown in FIG. 6, the first arm portion 234 is locked relative to the cross member 210. As the growing season advances further, the grapevines may need to be trained to a further elevated position and the arm portions 234 and 236 are moved to the position shown in FIG. 7 with the wires 212 at the further elevated position. In the position shown in FIG. 7, the first arm portion 234 and second arm portion 236 are both extending vertically upward and are fully extended and locked. At this position, the grapevine foliage is raised to its highest position on the trellis assemblies 202. When harvest is finished and the growing cycle is in its dormant season, dormant pruning may occur with the trellis assembly 202 positioned as shown in FIG. 7. Following dormant pruning, the arm assemblies 206 are again lowered to the position shown in FIG. 5. It can be appreciated that the arm assemblies 206 are moved to the various positions without having the wires 212 removed from the wire clips 208 and without the wires 212 crossing one another. Tangling is avoided as may occur with unclipping and moving the wires to different locations on the trellis, rather than moving the arms of the trellis, as shown in the present invention.

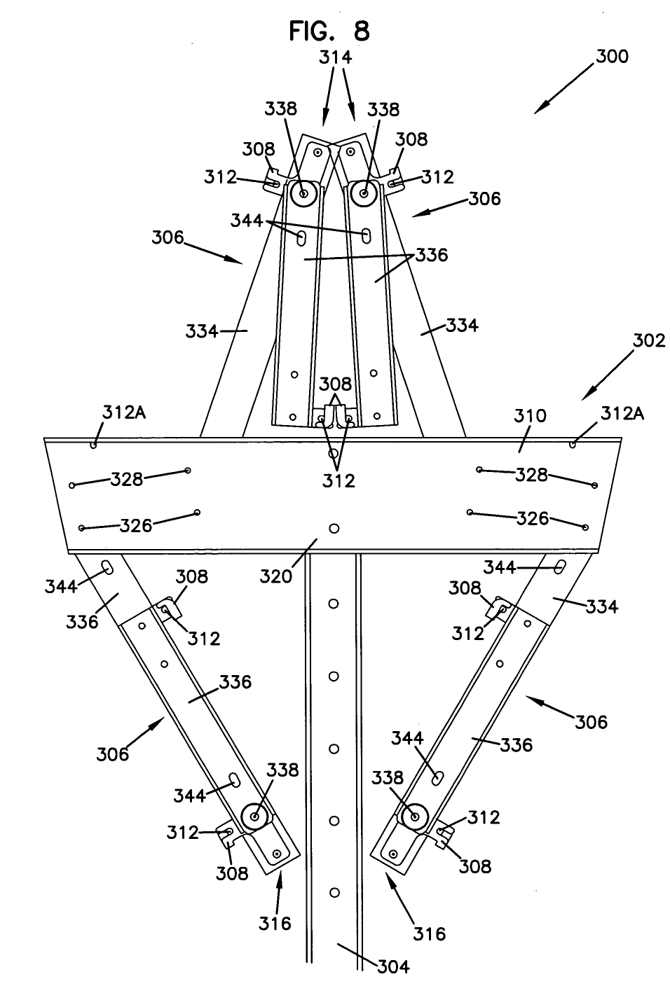

Referring now to FIGS. 8-10, there is shown a third embodiment of a trellis system according to the principles of the present invention, generally designated 300. The trellis system 300 includes individual trellis assemblies 302 supporting wires 312. The trellis system 300 is similar to the trellis system 200 shown in FIGS. 5-7, except the trellis system 300 includes four arm assemblies 306, including two inner arm assemblies 314, and two outer arm assemblies 316, supported at each end of a cross member 310. Therefore, the trellis system 300 retains up to eight wires 312 supporting foliage. Each trellis assembly 302 is mounted on the post 304 having the cross member 310 at an upper end thereof mounted by a post attachment portion 320. The cross member 310 may also be retrofitted to an existing post to modify vineyards for practicing the principles of the present invention. Typically, two cordon wires 312A are supported by the cross member 310, which has orifices receiving the cordon wires 312A, which are not moved and support cordons. The cross member 310 supports the four arm assemblies 306, including two of the inner arm assemblies 314 and two of the outer arm assemblies 316. The arm assemblies 314 and 316 support wire clips 308 that retain the wires 312, but allow the wires 312 to slide through the clips 308. Each of the arm assemblies 306 includes an inner arm portion 344 and an outer arm portion 336. The inner arm portion 334 pivotally mounts to the cross member 310 at pivot 326 while the outer arm portion 336 pivotally mounts to the inner arm portion 334 at pivot 338. Each of the pivots 326 and 338 includes a flexible bushing, typically in the form of a rubber washer that allows rotation about the pivot, but provides sufficient frictional resistance to normally hold the arm assemblies 306 in position. For extending the arm portions 334 and 336 upward while supporting wires 312 and grapevines where additional loads are placed on the arms, locks 328 and 340 are utilized. Each of the locks 328 and 340 includes a raised portion 342 on one member extending into a complementary receiver portion 344 of another member. The arm assemblies 306 function in substantially the same manner as the arm assemblies 106 and 206 as shown in FIGS. 2-7.

Referring to FIG. 8, in a lyre type trellis configuration modified to practice the principles of the present invention, the arm positioning is slightly different than the trellis system shown in FIGS. 2-7. Spacing of the arm assemblies 306 is different to accommodate the two additional arms and sets of wires than those included in the trellis systems shown in FIGS. 2-7.

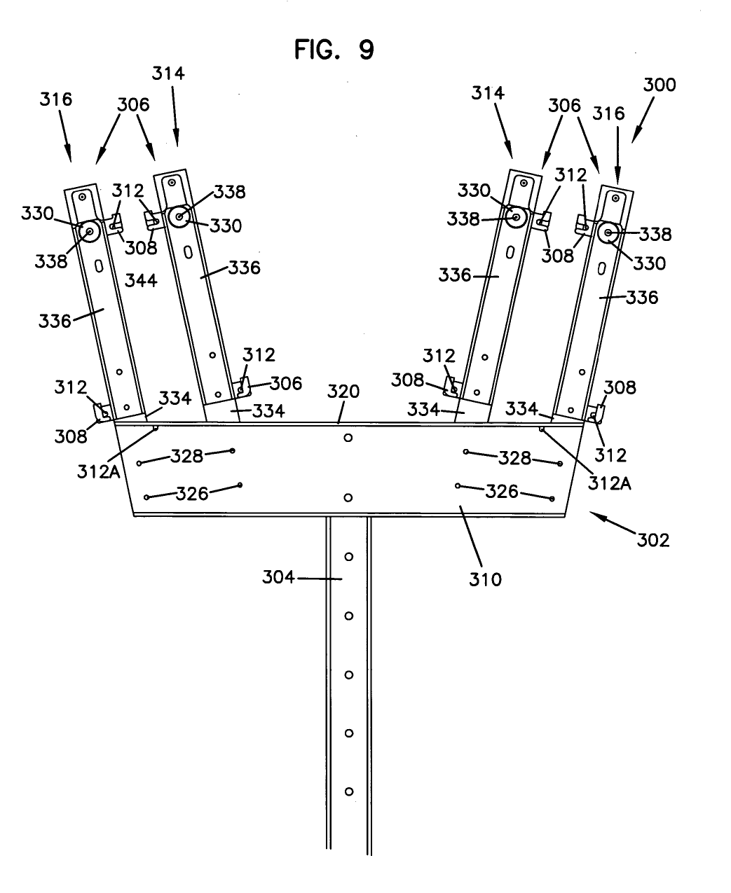

In the storage position, the outer arms 316 extend downward and may be angled inward in a manner similar to that shown in FIGS. 2 and 5. The inner arms 314 must be positioned differently so that the wires 312 do not overlap and tangling of the wires 312 is prevented. The first portions 344 of the inner arms 314 extend upward and inward while the second portions 336 extend substantially downward. The first portions 334 and second portions 336 of the inner arms 314 are not locked in the storage position shown in FIG. 8. The outer arms 316 do not need to be locked as they extend substantially downward. As the growing season advances and the foliage needs to be moved to a higher position, the arms 314 and 316 are repositioned. The first portions 334 of the inner arms 314 are moved to a locked position that may extend slightly outward, as shown in FIG. 9. The second arm portions 336 are allowed to hang downward and may substantially overlap the first arm portions 334. The outer arms 316 are also moved to an upward extending position with the arms 316 being pivoted outward and upward so that the arms 314 and 316 do not overlap and the wires 312 do not become entangled. The outer arms 316 have the first arm portions 334 locked relative to the cross member 310. The second arm portions 336 hang downward substantially from their pivot 338.

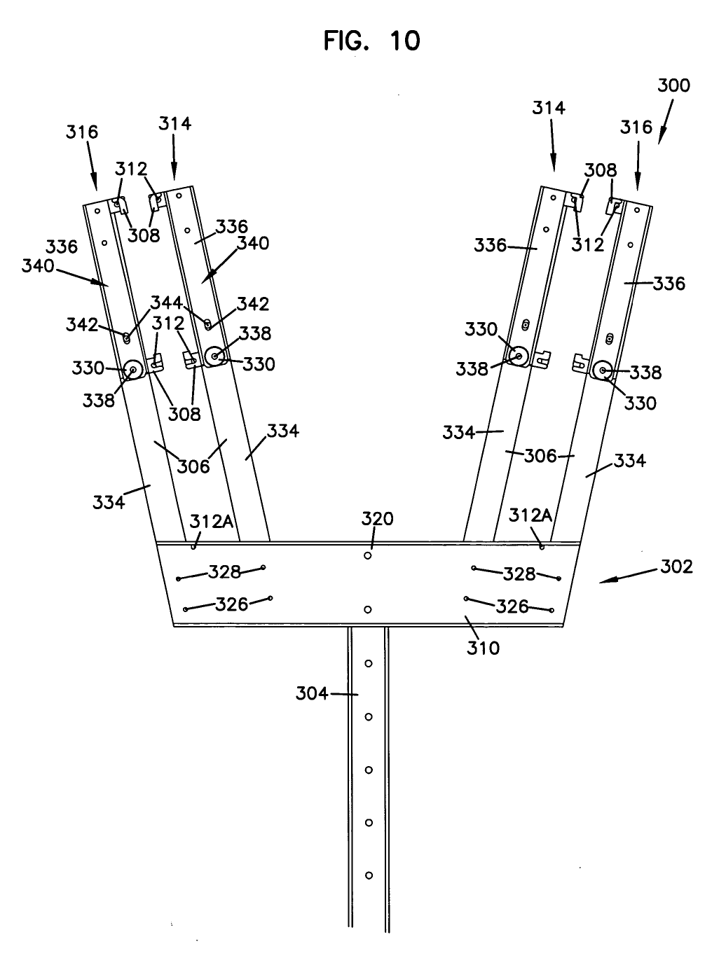

As the growing season advances further and the grape foliage is raised to the substantially full growth position, all of the arm assemblies 306 are positioned to be fully upward extending, as shown in FIG. 10. At this position, both the first arm portion 334 and the second arm portion 336 are locked and extend substantially upward. Each of the arm assemblies 306 may extend slightly outward relative to the post 304. Moreover, it can be appreciated that the present invention provides for folding and pivoting of the second arm portions 336 without overlapping. The second arm portions 336 of the outer arms 316 are pivoted outward and upward while the second arm portions 336 of the inner arms 314 are pivoted inward and upward so that no overlapping or tangling of wires occurs. Following harvest, dormant pruning may be conducted. The wires 312 are then lowered by moving the arm assemblies 306 to the lowered dormant season position shown in FIG. 8. The growing cycle and the positioning cycle of the foliage and the arms 314 and 316 then begin again. Shoot thinning and/or mechanized grape management operations may be conducted in this configuration prior to raising the arm assemblies 306.

It is to be understood, however, that even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the full extent indicated by the broad general meaning of the terms in which the appended claims are expressed.

1. A grape vine trellis comprising:
a trellis support member;
an arm movably mounted to the support member; and
at least one wire retainer attached to the arm.

2. A trellis according to claim 1, wherein the support member further comprises a cross member mounted proximate an upper end of the support member.

3. A trellis according to claim 1, wherein the arm supports the retainer at a first elevation at a first position and at a second elevation at a second position.

4. A trellis according to claim 3, wherein the arm is movable to a third position, and wherein the retainer is supported at a third elevation at the third position.

5. A trellis according to claim 3, wherein the arm projects downward at the first position and upward at the second position.

6. A trellis according to claim 1, wherein at least two retainers are on the arm in a spaced apart relationship.

7. A trellis according to claim 1, wherein the arm is configurable in a first length and a second length.

8. A trellis according to claim 3, wherein the arm is configurable in a first length and a second length.

9. A trellis according to claim 1, wherein the trellis comprises two arms supported on the cross member.

10. A trellis according to claim 9, wherein the arms are on opposite sides of the trellis.

11. A trellis according to claim 1, wherein the trellis support member is adaptable to be retrofit to an existing trellis.

12. A trellis according to claim 1, wherein the at least one wire retainer is adapted to provide relatively sliding between a retained wire and an associated wire retainer.

13. A vineyard trellis system comprising:
a plurality of trellises, wherein each trellis includes a trellis support member, an arm movably mounted to the support member, and at least a first wire retainer attached to the arm;
a first wire held by the first wire retainer on the plurality of trellises.

14. A system according to claim 13, wherein the arm is pivotally mounted.

15. A system according to claim 14, wherein the arm is configurable in a first length and a second length.

16. A system according to claim 13, wherein the arm is movable between a first position whereat the wire is held at a first height and a second position whereat the wire is held at a second height.

17. A system according to claim 16, wherein the arm is movable to a third position whereat the wire is held at a third height.

18. A system according to claim 13, wherein the arm includes a second wire retainer holding a second wire spaced-apart from the first wire.

19. A system according to claim 13, wherein the trellis comprises an arm positioned at a first side of the trellis and an arm positioned at a second side of the trellis.

20. A trellis according to claim 13, wherein the wire retainer is adapted to provide relatively sliding between a retained wire and an associated wire retainer.

21. A grape vine trellis comprising:
a support member;
a cross member mounted proximate an upper end of the vertical support member;
an arm mounted to the cross member and movable between a first position and a second position; and
at least one wire retainer on the arm.

22. A trellis according to claim 21, wherein the arm supports the retainer at a first elevation at the first position and at a second elevation at the second position.

23. A trellis according to claim 22, wherein the arm is movable to a third position and wherein the retainer is supported at a third elevation at the third position.

24. A trellis according to claim 21, wherein the arm projects downward at the first position and upward at the second position.

25. A trellis according to claim 21, wherein at least two retainers are on the arm in a spaced apart relationship.

26. A trellis according to claim 21, wherein the arm is movable to a third position

27. A trellis according to claim 21, wherein the arm is configurable in a first length and a second length.

28. A trellis according to claim 21, wherein the arm pivotally mounts to the cross member.

29. A trellis according to claim 28, wherein the arm is configurable in a first length and a second length.

30. A trellis according to claim 21, wherein the trellis comprises two arms supported on the cross member.

31. A trellis according to claim 30, wherein the arms are on opposite sides of the trellis.

32. A trellis according to claim 21, wherein the trellis is selected from the group of trellises types consisting of: VSP (vertical shoot positioned), T-top, California sprawl and other single curtain type trellis systems, Scott-Henry, Smart-Dyson and other single curtain vertically divided type trellis systems, quadrilateral sprawl, Livingston Double Curtain (LDC), Lyre, modified Lyre, Geneva Double Curtain (GDC) and other double curtain horizontally divided type trellis systems, Smart-Dyson Ballerina and other multiple curtain divided canopy trellis systems, as well as other similar trellis systems.

33. A trellis according to claim 21, wherein the arm includes two wire retainers spaced apart on the arm.

34. A grape vine trellis comprising:
a substantially vertical member;
a cross member mounted proximate an upper end of the vertical member and having first and second ends;
a first arm movably mounted at the first end of the cross member and a second arm movably mounted at the second end of the cross member;
first and second wire retainers mounted on each of the arms;
wherein the arms move from a first position wherein the arms project downward, to a second position wherein the arms project upward, to a third position wherein the arms project upward and are configured at a length greater than a length at the second position.

35. A method of positioning a foliage on a trellis, comprising:
providing a trellis having a support and an arm moveable between a lower first position and a higher second position, wherein the arm retains a wire;
positioning the arm at the first position;
supporting the foliage on the wire; and
after a first period of growth, raising the arm while retaining the wire, thereby raising the foliage.

36. A method according to claim 35, wherein the arm is configurable in a first length and a second length greater than the first length, and wherein the arm is configured at the second length after a second period of growth.

37. A method according to claim 35, wherein the trellis comprises a plurality of arms.
